(19) United States
(12) Patent Application Publication
(10) Pub. No.: US 2026/0311675 A1
(43) Pub. Date: Oct. 8, 2026

(54) Manually Operated Actuator and Method for Controlling a Manually Operated Actuator

(71) Applicant: Dr. Ing. h.c. F. Porsche Aktiengesellschaft, Stuttgart (DE)

(72) Inventors: Manuel Kühner, Petersberg (Marbach) (DE); Simon Lipphardt, Holzgerlingen (DE)

(73) Assignee: Dr. Ing. h.c. F. Porsche Aktiengesellschaft, Stuttgart (DE)

(21) Appl. No.: 19/640,849

(22) Filed: Apr. 7, 2026

(30) Foreign Application Priority Data
Apr. 8, 2025 (DE) 10 2025 113 793.5

(51) Int. Cl. G10K 15/04; B60K 20/02; F16H 59/02; F16H 59/04; G05G 5/03; G06F 3/16

(52) U.S. Cl. CPC G10K 15/04; B60K 20/02; F16H 59/0204; F16H 59/044; G05G 5/03; G06F 3/165; F16H 2059/0295; G05G 2505/00

(57) ABSTRACT

A manually operated actuator for actuating a transmission of a motor vehicle. The actuator includes an actuator housing, an actuating lever pivotably mounted in the actuator housing along at least one actuation path, at least one controllable actuator which exerts a force on the actuating lever in order to influence the resistance forces acting on the actuating lever during actuation of the actuating lever and influence the actuation feel of the actuating lever. The actuating lever is supported in at least one stable rest position by at least one spring assembly with spring elements. A sensor monitors the actuation force acting on the actuating lever and/or the acceleration of the actuating lever. An acoustic output element is arranged in the actuating lever or in the actuator housing, in order to generate acoustics of a sound associated with a shifting operation when the actuating lever is displaced.

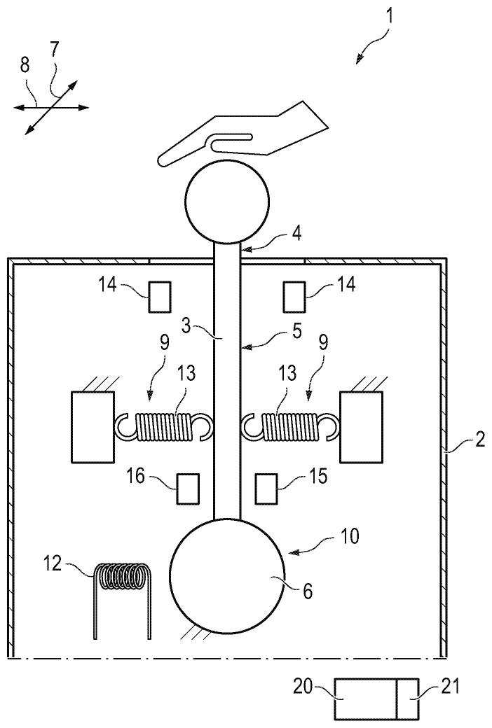

### CROSS-REFERENCE TO RELATED APPLICATION

This application claims priority to German Patent Application No. 10 2025 113 793.5, filed Apr. 8, 2025, the content of such application being incorporated by reference herein in its entirety.

### FIELD OF THE INVENTION

The invention relates to a manually operated actuator and a method for controlling a manually operated actuator, in particular for a motor vehicle.

### BACKGROUND OF THE INVENTION

Motor vehicles often include, for example, a shift lever for shifting a manual transmission or a selector lever for operating an automatic transmission. The shift lever is mechanically coupled to the manual transmission to shift the gears of the manual transmission. Such a motor vehicle also comprises a clutch in the powertrain and a clutch pedal for actuating the clutch.

In comparison, a motor vehicle with an automatic transmission does not have a clutch to be actuated by the driver, and correspondingly does not have a clutch pedal either. The selector lever is mechanically coupled to the automatic transmission.

In many modern motor vehicles, the shift lever and the selector lever are typically omitted and replaced with operating buttons, which saves costs and allows automated, electronically controlled operation of the automatic transmission. However, fully automated control of motor vehicles is not desired by every driver because it also makes individual driver intervention more difficult or prevents it, which is still preferred by some drivers.

Accordingly, there is a desire for remanualization of motor vehicles in order to be able to perform certain functionalities manually again, for example manual operation of the automatic transmission as a manual transmission and/or sequential shifting of the automatic transmission.

However, this requires that a manually operated actuator be usable, which is equipped with an actuating lever with which, in a first mode, the respective manual actuation can be performed and/or, in a second mode, sequential shifting can be performed, so that the manually operated actuator is suitable both for shifting an automatic transmission and for shifting an automatic transmission in the manner of a manual transmission, or can emulate this. The driver is thus to have the choice as to whether to drive the vehicle and shift the existing transmission, or, in an electric vehicle, an existing electric motor, as if a manual transmission or an automatic transmission were provided. An electronically controllable clutch pedal may also be provided to emulate clutch actuation with an emulated manual transmission.

However, it is also desirable for the manually operated actuator, with its actuating lever, to have suitable acoustics in order to provide the operator or the driver of the motor vehicle with a realistic experience of shifting a manual transmission or an automatic transmission.

### SUMMARY OF THE INVENTION

Described herein is a manually operated actuator equipped with an actuating lever, and with improved acoustics, to create a realistic shifting experience. Also described herein is an improved method for controlling a manually operated actuator, which allows improved acoustics to create a realistic shifting experience.

An exemplary embodiment of the invention relates to a manually operated actuator, in particular for actuating a transmission, in particular of a motor vehicle, with an actuator housing and an actuating lever, wherein the actuating lever is pivotably mounted in the actuator housing along at least one actuation path, wherein at least one controllable actuator is provided, which exerts a force on the actuating lever in order to influence the resistance forces acting on the actuating lever during actuation of the actuating lever, in order to influence the actuation feel of the actuating lever, wherein the actuating lever is arranged such that it is supported in at least one stable rest position by means of at least one spring assembly with spring elements, wherein at least one sensor is provided, by means of which the actuation force acting on the actuating lever and/or the acceleration of the actuating lever can be monitored, wherein an acoustic output element is provided, which is arranged in the actuating lever or in the actuator housing, in order to generate acoustics of a sound associated with a shifting operation when the actuating lever is displaced. Thus, it is achieved that an adequate noise is generated in parallel in time with the mechanical displacement of the actuating lever in order to provide the driver with a hearing experience comparable to a shifting operation of a manual transmission, although the manual shifting is only simulated.

In an exemplary embodiment, it is also expedient for the acoustic output element to be at least one speaker. This at least one speaker is integrated in the manually operated actuator, so that the manually operated actuator is the source of the noises, which comes very close to the reality of a manual transmission and is therefore considered very realistic.

It is also expedient to provide a control unit with a memory, wherein at least one acoustic file with a stored noise of a shifting operation is stored in the memory. Thus, a realistic noise can be produced that is known to the driver of a vehicle with a manual transmission. It is also expedient if, for example, different noises can be selected and/or the generated noise also varies depending on the driving mode.

It is also expedient if the control unit causes an acoustic file to be played back to generate a noise based on a sensor signal from the sensor. This causes the noise to be generated at the same time as the mechanical actuation of the actuating lever, in order to make the acoustics realistic.

It is also particularly advantageous if the control unit controls the timing, duration, and/or volume of playback of the acoustic file to generate a noise based on a sensor signal from the sensor. This creates particularly synchronous acoustics with the mechanical movement of the actuating lever.

It is particularly advantageous if the control unit controls playback of the acoustic file to generate a noise synchronously with the displacement of the actuating lever.

An exemplary embodiment of the invention relates to a method for controlling a manually operated actuator, in particular for actuating a transmission, in particular of a motor vehicle, with an actuator housing and an actuating lever, wherein the actuating lever is pivotably mounted in the actuator housing along at least one actuation path, wherein at least one controllable actuator is provided, which exerts a force on the actuating lever in order to influence the resistance forces acting on the actuating lever during actuation of the actuating lever, in order to influence the actuation feel of the actuating lever, wherein the actuating lever is arranged such that it is supported in at least one stable rest position by means of at least one spring assembly with spring elements, wherein at least one sensor is provided, by means of which the actuation force acting on the actuating lever and/or the acceleration of the actuating lever is monitored, wherein an acoustic output element is provided, which is arranged in the actuating lever or in the actuator housing, in order to generate acoustics associated with a shifting operation when the actuating lever is displaced. Thus, it is achieved that an adequate noise is generated in parallel in time with the mechanical displacement of the actuating lever in order to provide the driver with a hearing experience comparable to a shifting operation of a manual transmission, although the manual shifting is only simulated.

It is also advantageous if a control unit with a memory is provided, wherein at least one acoustic file with a stored noise of a shifting operation is stored in the memory, wherein the control unit causes playback of an acoustic file to generate a noise by means of the acoustic output element based on a sensor signal from the sensor. Thus, it is possible to generate a realistic noise of the shifting operation.

It is also expedient if the control unit controls the timing, duration, and/or volume of playback of the acoustic file to generate a noise based on a sensor signal from the sensor. This makes it possible to generate a very realistic noise of the shifting operation.

It is particularly advantageous if the control unit controls playback of the acoustic file to generate a noise synchronously with the displacement of the actuating lever. This makes it possible to generate a very realistic noise of the shifting operation.

### BRIEF DESCRIPTION OF THE DRAWINGS

The invention is described in detail in the following on the basis of an embodiment example with reference to the drawing. The drawing shows:

The FIGURE is a schematic illustration of an exemplary embodiment of a manually operated actuator with an actuating lever of a motor vehicle to explain the invention.

### DETAILED DESCRIPTION OF THE INVENTION

The FIGURE shows an exemplary embodiment of a manually operated actuator 1 of a motor vehicle in a schematic illustration. The manually operated actuator 1 is used to emulate shifting of a transmission, wherein no mechanical connection is provided between the actuating lever 3 and a transmission or an electric motor, such that shifting of a manual transmission or an automatic transmission in a vehicle with an automatic transmission or an electric motor can be performed or emulated. For this purpose, an electronically controlled clutch pedal may also be provided, which would be actuated when shifting the manual transmission.

The manually operated actuator 1 comprises an actuator housing 2 and an actuating lever 3, which is displaceably mounted in the actuator housing 2.

The actuating lever 3 typically comprises a first lever arm region 4 and a second lever arm region 5. The actuating lever 3 is pivotably mounted in the actuator housing 2 by means of a bearing 6, such that the first lever arm region 4 projects outward from the actuator housing 2, typically upward, and the second lever arm region 5 projects into the actuator housing 2.

When the actuating lever 3 is displaced, the actuating lever 3 in the actuator housing 2 can be displaced laterally in accordance with direction 7 as well as transversely in accordance with direction 8.

According to the exemplary embodiment of the manually operated actuator 1 shown in the FIGURE, at least a first spring assembly 9 is provided or a plurality of spring assemblies 9 are provided, which interact with the actuating lever 3. The respective spring assembly 9 is connected, for example, both to the actuator housing 2 and to the actuating lever 3 in order to transmit a force to the actuating lever 3 in the tensile and/or compressive direction, so that a first stable rest position is provided in the rest position or center position. The actuating lever 3 is thus arranged by means of the at least one spring assembly 9 with respect to a first stable rest position.

The tensile direction, for example, is a direction in which the respective spring assembly 9 exerts a tensile force on the actuating lever 3, and the compressive direction is a direction in which the spring assembly 9 exerts a compressive force on the actuating lever 3. In the case of two opposing spring assemblies 9, as shown in the FIGURE, the tensile and compressive directions of the respective spring assembly 9 are reversed for each spring.

According to a further concept of the inventor, the spring assembly 9 comprises at least one spring element 13, which is connected to both the actuating lever 3 and the actuator housing 2, such that the actuating lever 3 is displaceably arranged against a restoring force of the spring element 13; in particular, the spring assembly 9 comprises at least two spring elements 13, which are connected to both the actuating lever 3 and the actuator housing 2, such that the actuating lever 3 is displaceably arranged against a restoring force of at least one spring element 13.

Furthermore, a controllable actuator 10 is arranged, which acts on the actuating lever 3.

The actuating lever 3 may be displaceable in the actuator housing 2 in at least one path, or in a plurality of paths, in the first transverse direction 8 and may be supported so as to be displaceable transversely to the path or paths in the second lateral direction 7. Preferably, the stable rest position is positioned in a first path.

According to the exemplary embodiment shown, the actuating lever 3 is arranged so as to be pivotably mounted in a bearing 6 about at least one axis, and the actuator 10 forms the bearing 6 or is a part of the bearing 6.

In a preferred embodiment, the actuator 10 is a magnetorheological actuator or comprises such a magnetorheological actuator.

Alternatively, the at least one actuator 10 may also be, for example, an electric motor actuator.

According to the exemplary embodiment shown, the actuator 10 comprises at least one solenoid 12 or an electromagnet. The at least one magnetorheological actuator 10 is switched or controlled thereby.

The actuating lever 3 is arranged in the actuator housing 2 so as to be pivotable along at least one actuation path, wherein the respective actuation path provides end stops 14 at its ends, against which the actuating lever 3 can come to rest when it is pivoted that far. However, the spring elements 13 and also the at least one actuator 10 counteract the displacement of the actuating lever 3 toward the end stops 14.

Accordingly, the at least one controllable actuator 10 is provided, which exerts a force on the actuating lever 3 in order to influence the resistance forces acting on the actuating lever 3 when actuating the actuating lever 3, in order to influence the actuation feel of the actuating lever 3. For example, the at least one actuator 10, as a magnetorheological actuator 10, is an actuator 10 that brakes or blocks actuation of the actuating lever 3, wherein the magnitude of the acting force can be controlled. A magnetorheological actuator 10 is therefore suitable for influencing the actuation feel of the actuating lever 3.

In the exemplary embodiment shown, the actuating lever 3 is monostably mounted with respect to a rest position by means of at least one spring assembly 9 with spring elements 13. The actuating lever 3 can also be multistably arranged.

Furthermore, at least one sensor 15 is provided, by means of which the position of the actuating lever 3 is monitored. The actuating force acting on the actuating lever 3 and/or the acceleration of the actuating lever 3 can also be monitored by means of the sensor 15. This indicates how the driver moves the actuating lever 3, with what force and/or at what speed.

Furthermore, an acoustic output element 16 is provided, which is arranged in the actuating lever 3 or in the actuator housing 2 in order to generate the acoustics of a noise associated with a shifting operation during the displacement of the actuating lever 3.

The acoustic output element 16 is at least one speaker, but a plurality of speakers can also be provided.

Furthermore, a control unit 20 with a memory 21 is provided, wherein at least one acoustic file with a stored noise of a shifting operation is stored in the memory 21. Various acoustic files may also be stored, which can be used as needed and depending on the application. For example, different acoustic files with different noises can also be used in different driving programs.

Preferably, the control unit 20 causes an acoustic file to be played back to generate a noise based on a sensor signal from the sensor 15.

It is also expedient if the control unit 20 controls the timing, duration, and/or volume of playback of the acoustic file to generate a noise based on a sensor signal from the sensor 15.

In particular, the control unit 20 controls playback of the acoustic file to generate a noise synchronously with the displacement of the actuating lever 3.

The method according to aspects of the invention provides that at least one sensor 15 is provided, by means of which the actuating force acting on the actuating lever 3 and/or the acceleration of the actuating lever 3 is monitored, wherein the acoustic output element 16 is provided, which is arranged in or on the actuating lever 3 or in the actuator housing 2 in order to generate acoustics associated with a shifting operation during the displacement of the actuating lever 3. Thus, an acoustic sound is assigned to the mechanical actuation of the actuating lever 3, which the driver perceives as realistic.

It is also particularly advantageous in the method if the control unit 20 is provided with the memory 21, wherein at least one acoustic file with a stored noise of a shifting operation is stored in the memory 21, wherein the control unit 20 causes an acoustic file to be played by means of the acoustic output element 16 to generate a noise based on a sensor signal from the sensor 15.

It is also particularly preferred if the control unit 20 controls the timing, duration, and/or volume of the playback of the acoustic file to generate a noise based on a sensor signal from the sensor 15, in particular that the control unit 20 controls the playback of the acoustic file to generate a noise synchronously with the displacement of the actuating lever 3.

### List of Reference Numerals

1 Manually operated actuator
2 Actuator housing
3 Actuating lever
4 First lever arm region
5 Second lever arm region
6 Bearing
7 Lateral direction
8 Transverse direction
9 Spring assembly
10 Actuator
12 Solenoid
13 Spring element
14 End stops
15 Sensor
16 Acoustic output element
20 Control unit
21 Memory

What is claimed:

1. A manually operated actuator for actuating a transmission of a motor vehicle, said manually operated actuator comprising:
an actuator housing;
an actuating lever that is pivotably mounted in the actuator housing along at least one actuation path;
at least one controllable actuator that exerts a force on the actuating lever in order to influence resistance forces acting on the actuating lever during actuation of the actuating lever as well as influence an actuation feel of the actuating lever;
at least one spring assembly with spring elements for supporting the actuating lever in at least one stable rest position;
at least one sensor for monitoring (i) an actuation force acting on the actuating lever and/or (ii) an acceleration of the actuating lever; and
an acoustic output element arranged in the actuating lever or in the actuator housing that generates a sound associated with a shifting operation when the actuating lever is displaced.

2. The manually operated actuator according to claim 1, wherein the acoustic output element is at least one speaker.

3. The manually operated actuator according to claim 1, further comprising a control unit with a memory, wherein at least one acoustic file with a stored sound of a shifting operation is stored in the memory.

4. The manually operated actuator according to claim 3, wherein the control unit causes the at least one acoustic file to be played to generate a sound based on a sensor signal from the sensor.

5. The manually operated actuator according to claim 4, wherein the control unit controls a timing, duration and/or volume of the playing of the acoustic file to generate the sound based on the sensor signal from the sensor.

6. The method according to claim 4, wherein the control unit controls the playing of the acoustic file to generate the sound synchronously with a displacement of the actuating lever.

7. In a manually operated actuator for actuating a transmission of a motor vehicle, said manually operated actuator comprising: an actuator housing, an actuating lever that is pivotably mounted in the actuator housing along at least one actuation path, at least one controllable actuator which exerts a force on the actuating lever in order to influence resistance forces acting on the actuating lever during actuation of the actuating lever and influence an actuation feel of the actuating lever, at least one spring assembly with spring elements for supporting the actuating lever in at least one stable rest position, at least one sensor for monitoring an actuation force acting on the actuating lever and/or an acceleration of the actuating lever, and an acoustic output element arranged in the actuating lever or in the actuator housing, a method for controlling the manually operated actuator comprises:
generating a sound associated with a shifting operation when the actuating lever is displaced using the acoustic output element.

8. The method according to claim 7, wherein a control unit with a memory is provided, wherein at least one acoustic file with a stored sound of a shifting operation is stored in the memory, wherein the control unit causes an acoustic file to be played by the acoustic output element to generate the sound based on a sensor signal from the sensor.

9. The method according to claim 8, wherein the control unit controls a timing, duration and/or volume of the playing of the acoustic file to generate the sound based on the sensor signal from the sensor.

10. The method according to claim 8, wherein the control unit controls the playing of the acoustic file to generate the sound synchronously with the displacement of the actuating lever.
